(19) United States
(12) Patent Application Publication
(10) Pub. No.: US 2024/0326642 A1
(43) Pub. Date: Oct. 3, 2024

(54) A SYSTEM FOR QUICK INTEGRATION AND REMOVAL OF BATTERY IN VEHICLES

(71) Applicant: PRAVAIG DYNAMICS PRIVATE LIMITED, Delhi (IN)

(72) Inventors: Dhawal KHULLAR, Rajasthan (IN); Siddhartha BAGRI, New Delhi (IN)

(73) Assignee: PRAVAIG DYNAMICS PRIVATE LIMITED, Delhi (IN)

(21) Appl. No.: 18/577,625

(22) PCT Filed: Jul. 7, 2022
(86) PCT No.: PCT/IB2022/056283

§ 371 Date: Jan. 8, 2024

(30) Foreign Application Priority Data
Jul. 9, 2021 (IN) 202141030951

(51) Int. Cl. B60L 53/80; H01M 50/249; H01M 50/262

(52) U.S. Cl. CPC B60L 53/80; H01M 50/249; H01M 50/262; H01M 2220/20

(57) ABSTRACT

The present invention relates to a battery locking and release system 100 of a vehicle 10. The locking and release system 100 includes a battery 20, a battery bay 14, a plurality of male engagements 110 and a plurality of female cavities 150. The plurality of male engagements 110 are disposed on a battery bay 14 of the vehicle 10 and the plurality of female cavities 150 are disposed on the battery 20. For allowing an engagement and/or a disengagement of the battery 20 with the battery bay 14, the plurality of female cavities 150 on the battery 20 reversibly engages with the plurality of the male engagements 110 in the battery bay 14 of the vehicle 10. The present invention does not require special tools like screwdrivers, nuts, bolts etc. for installation and removal of batteries 20 from the battery bay 14 of the vehicle 10.

### FIELD OF INVENTION

The present invention relates to a field of electric vehicles and more particularly, to an easily detachable battery package coupled with a chassis of the electric vehicle.

### BACKGROUND OF THE INVENTION

Electric vehicles are considered to be a long-term solution to curb utilisation and exhaustion of fossil fuel powered-conventional vehicles. Electric vehicles are powered by an electric motor drawing energy from a battery and thus, emitting no exhaust into the atmosphere.

The drawback of an electric car is the need for intermittent recharging of the batteries. The battery of the electric vehicle is generally charged at charging stations, which is a time-consuming process. The other option for replenishing the battery is exchanging a discharged battery with a fully charged battery at a battery changing station.

Battery changing stations are manual, semi-automated or fully automated systems, assisting in removal and mounting of batteries from the electric vehicles. This system utilises removal of the battery from chassis of the electric vehicle using a screwdriver setup for screwing and unscrewing. The automation, infrastructure and mechanical parts utilised in such systems are more, leading to high cost of maintenance of such systems.

Thus, there is a long felt need for an electric vehicle car design that allows coupling of the battery into existing vehicle structure, thereby making the installation and removal of batteries from vehicles easy and further allowing the battery changing system to use fewer mechanical components and functions.

In the known art, significant contributions have been made on battery installation and removal systems for electric vehicles. US20120305323 discloses a device for attaching an electric battery to a chassis of a motor vehicle and including a first quarter-turn attachment mechanism to be rigidly connected to the chassis of the motor vehicle, and a second quarter-turn attachment mechanism to be rigidly connected to the electrical battery, the first and second quarter-turn attachment mechanisms being configured to engage to attach the electric battery to the chassis of the motor vehicle.

US20180086193 relates to a battery swap connector and an electric vehicle comprising the same. This publication utilizes a plug and a socket for attachment of battery to vehicle, wherein the plug is adapted to be connected to a power battery end of the electric vehicle so as to output electrical energy from the power battery, and the socket is adapted to be connected to a vehicle body end of the electric vehicle so as to transmit the electrical energy to individual electric components of the vehicle.

U.S. Pat. No. 8,517,132B2 discloses an electric vehicle that includes a battery pack that can be exchanged at a battery exchange station. In this granted patent publication, the battery has at least three latches each being mounted on the frame for rotation with respect to the frame and being engageable with respective strikers of the battery pack to mechanically couple the battery pack from the underside of the vehicle. At least one drive system being configured for simultaneously rotating all of the latches to simultaneously engage with the respective strikers and vertically lift the battery pack from the underside of the vehicle.

Though some of the existing arts teach a system for installing and uninstalling a battery in electric vehicle, but all of them utilize complex, mechanical parts for locking and releasing the battery from the vehicle. Further, the prior art technologies require use of tools for installing and uninstalling the battery into and from the vehicle.

Therefore, keeping in view the problems associated with state of the art, there is a clear requirement of a simple compliant mechanism which utilizes simple and less complex parts for locking and release of battery into the battery bay. The present disclosure is directed to overcome one or more of such problems in the existing art.

### OBJECTIVES OF THE INVENTION

An object of the present invention is to provide an integration and removal system of batteries in electric vehicles.

It is another object of the present invention to provide an integration and removal system of battery modules, having an integrated removal system.

Another object of the present invention to provide an integration and removal system which does not require special tools like screwdrivers, nuts, bolts etc. for installation and removal of batteries.

Yet another object of the present invention to provide a battery integration and removal system which is free from complex mechanical parts and hence, easy to maintain.

Still other objects, features, and advantages of the present invention will become evident to those of ordinary skill in the art in light of the following.

### BRIEF DESCRIPTION OF DRAWINGS

The foregoing and other objects, features and advantages of the invention will be apparent from the following more particular description of particular embodiments of the invention, as illustrated in the accompanying drawings in which like reference characters refer to the same parts throughout the different views. The drawings are not necessarily to scale, emphasis instead being placed upon illustrating principles of the invention.

FIG. 1 is an exploded view illustrating a lock and release mechanism for a battery of a vehicle;

FIG. 2A is a perspective view illustrating a male engagement projection having an inverted alphabet “U” shape;

FIG. 2B is a perspective view illustrating a connector of the male engagement flexed in an upward motion due to pulling of a push pull rod;

FIG. 3 is a perspective view illustrating a plurality of male engagement projection disposed in a plurality of brackets provided on a battery bay of the vehicle;

FIG. 4 is a perspective view of a battery of the vehicle showing a plurality of female cavities; and

FIG. 5 is a sectional view illustrating a pair of grooves of the female cavity on the battery of the vehicle.

### DETAIL DESCRIPTION OF EMBODIMENTS

As used in the specification and claims, the singular forms “a”, “an” and “the” include plural references unless the context clearly dictates otherwise. For example, the term “an article” may include a plurality of articles unless the context clearly dictates otherwise.

There may be additional components described in the foregoing application that are not depicted on one of the described drawings. In the event such a component is described, but not depicted in a drawing, the absence of such a drawing should not be considered as an omission of such design from the specification.

Detailed embodiments of the present invention are disclosed herein, however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The term “batteries” as used herein should be understood in a broad sense encompassing replaceable electrical energy providing modules of any kind whether commonly denominated “batteries”, “storage cells,” or some other nomenclature. Further, the terms battery or battery modules or battery packs may be used interchangeably.

Further, spatially relative terms, such as “beneath”, “below”, “lower”, “above”, “upper” and the similar, utilized herein for description of one element(s) or feature(s) relationship to other element(s) or feature(s) illustrated in the figures of the present invention. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

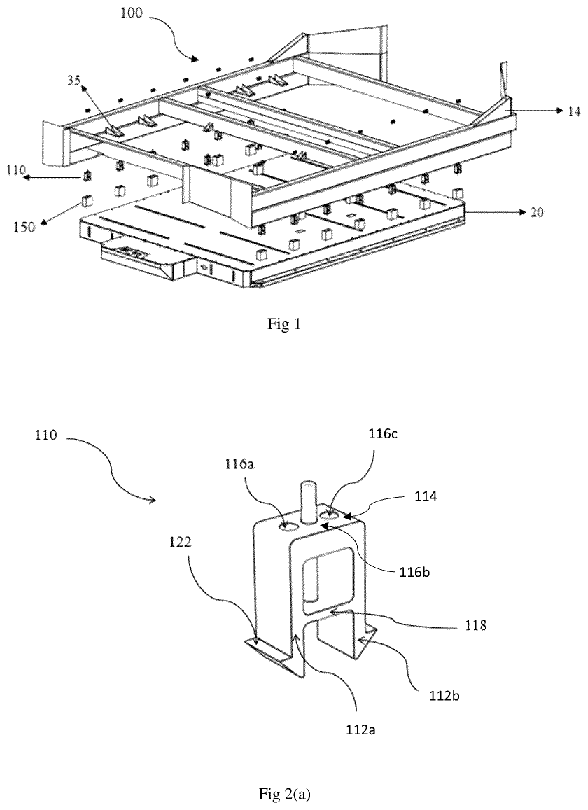

FIG. 1 illustrates an exploded view of a locking and release system 100 for a battery of a vehicle 10 as per an embodiment of the present invention. The locking and release system 100 includes a plurality of male engagements 110 disposed on a battery bay 14 of the vehicle 10 and a plurality of female cavities 150 disposed on a battery 20. The plurality of female cavities 150 on the battery 20 reversibly engages with the plurality of male engagements 110 in the battery bay 14 of the vehicle 10, allowing an engagement or a coupling of the battery 20 with the battery bay 14 of the vehicle 10 and/or a disengagement or a removal of the battery 20 from the battery bay 14 of the vehicle 10.

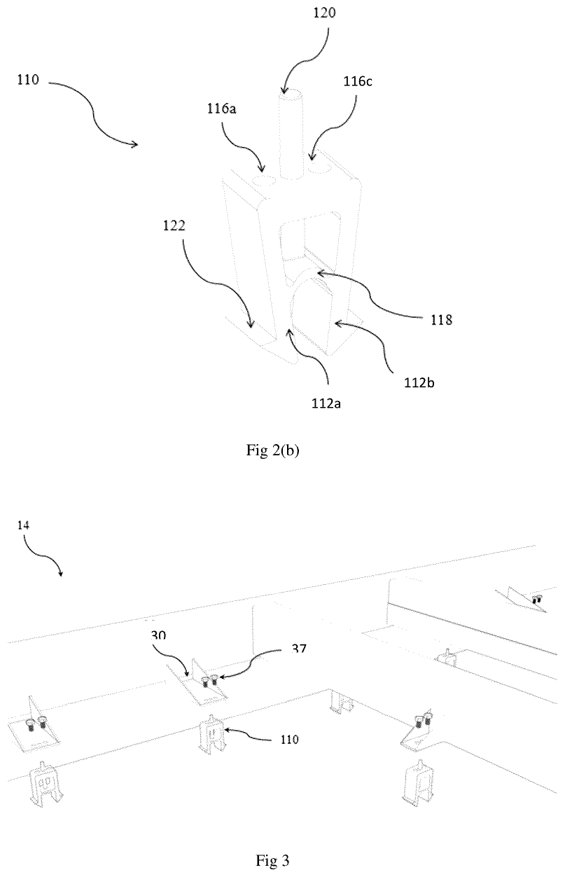

FIG. 2A is a perspective view of the plurality of male engagements 110 disposed onto the battery bay 14 of the vehicle 10. Each of the male engagements 110 include a pair of projections 112 and a flat member 114 joining the pair of projections 112, thus resembling an inverted alphabet “U”. The description of such shape however, should not be construed to be limiting to only the alphabet “U”. A plurality of openings 116 are provided on the flat member 114 of the male engagement 110. As per a preferred embodiment, the flat member 114 is provided with three openings 116a-c, i.e., a middle opening 116b and a pair of adjacent openings 116a and 116c.

A connector 118 is disposed between the pair of projections 112. The connector 118 is provided on an inner surface of the pair of projections 112, such that the connector 118 is parallel to the flat member 114 of the male engagement 110. The connector 118 is disposed at a distance from the flat member 114. The connector 118 is a thin and a flexible sheet made of a metal. A push-pull rod 120 is passed through the middle opening 116b of the flat member 114. The push-pull rod 120 is permanently connected to the connector 118 of the male engagement 110, as shown in FIG. 2A.

FIG. 2B illustrates the flexing of the connector 118 of the male engagement 110. The pulling and/or pushing of the push-pull rod 120 causes the connector 118 to flex. The pulling of the push-pull rod 120 causes the connector 118 to flex in an upward motion causing the pair of projections 112a and 112b to move closer to each other. Further, a ledge 122 is disposed onto an outer surface of each projection 112a-b of the pair of projections 112 of the male engagement 110. Each of the ledges 122 of the plurality of female cavities has a shape and configuration for locking into the plurality of female cavities 150, explained further in detail below.

FIG. 3 illustrates the male engagements 110 disposed directly or indirectly onto the battery bay 14 of the vehicle 10. In the preferred embodiment, each of the male engagements 110 is disposed on the battery bay 14 through a bracket 30. Each of the male engagements 110, connected to the battery bay 14 using the bracket 30 and secured using a pair of screws 37, pass through the pair of adjacent openings 116a and 116c on the flat member 114.

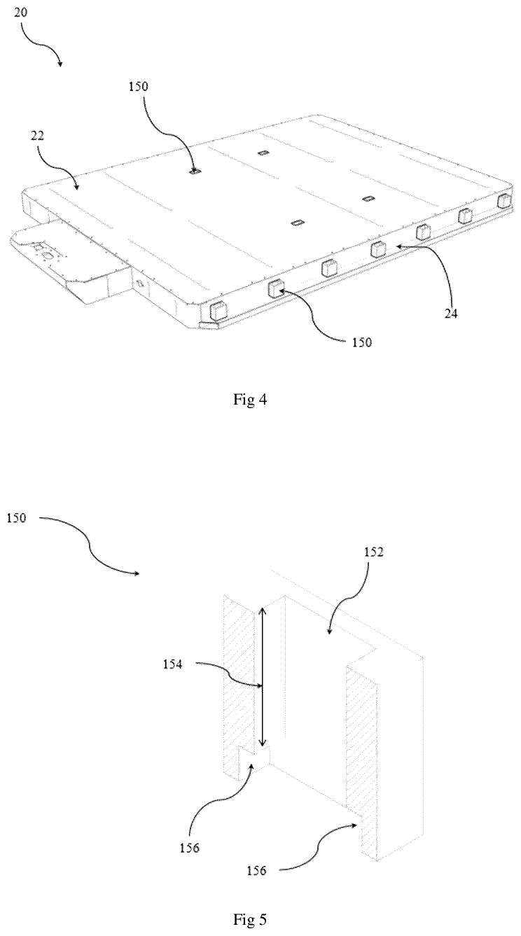

FIG. 4 illustrates the plurality of female cavities 150 disposed on the battery 20. The plurality of female cavities 150 are provided on a top surface 22 and each of a longitudinal surface 24 on the battery 20. As per an embodiment, the female cavity 150 can be an individual module attached to the top surface 22 and each of the longitudinal surfaces 24 of the battery 20, or integrated into the battery 20 or a combination thereof. As per a preferred embodiment, the plurality of female cavities 150 provided on the top surface 22 are integrated into the battery 20. Further, the female cavities 150 disposed on each of the longitudinal surfaces 24 of the battery 20 are individual modules.

FIG. 5 is a sectional view of the female cavity 150 on the battery 20 of the vehicle 10. The female cavity 150 includes an opening 152, a channel 154, and a pair of grooves 156. The female cavity 150 is an enclosed unit. A closed configuration of the female cavity 150 allows the male engagements 110 to be securely coupled. This enables to avoid any accidental disengagement of the male engagements 110 from the female cavities 150 caused due to various forces acting as a result of a movement of the vehicle 10.

A locking mechanism involves engagement of the plurality of male engagements 110 disposed onto the battery bay 14 of the vehicle 100 with the plurality of female cavities 150 on the battery 20, allowing the battery to be placed into the vehicle 10. A shape of the female cavity 150 is complementary to a shape of the male engagements 110, such that each of the ledge 122 of pair of projections 112 of the male engagements 110 interlocks with the pair of grooves 156 of the female cavity 150, as shown in figure, allowing to mount the battery 20 into the battery bay 14 of the vehicle 10.

The battery release mechanism involves pulling of the push-pull rod 120 provided through the middle opening 116b of the flat member 114, causing the connector 118 to flex in the upward motion and causing the pair of projections 112 to move closer to each other. This releases the male engagements 110 from the female cavity 150, releasing battery 20 from the battery bay 14 of the vehicle 10. Further, a push to the battery 20 is needed to mount it onto the battery bay 14 of the vehicle 10. The push causes the connector 118 to become flat for a moment and then interlocks the pair of grooves 156 of female cavity 150 to securely couple the battery 20. Hence, the engagement and disengagement of the battery 20 into the battery bay 14 does not require special tools like screwdrivers, nuts, bolts etc.

The action of engagement and disengagement of the battery 20 into the battery bay 14 causes a friction between the plurality of female cavities projections 112 and the plurality of female cavities 150, leading to wear and tear and causing loosening of a mechanical coupling. In order to avoid the wear and tear, the plurality of male engagements 110 and the plurality of female cavities 150 are surface treated with agents.

It should be understood that the present invention and its embodiments are explained with reference to its application in reversibly engaging the battery 20 in the battery bay 14 of the vehicle 10. The locking and release system can be used to reversibly engage any two surfaces and not limited only to use in vehicles.

The foregoing examples and illustrative implementations of various embodiments have been provided merely for explanation and are in no way to be construed as limiting of the embodiments disclosed herein. While the embodiments have been described with reference to various illustrative implementations, drawings, and techniques, it is understood that the words, which have been used herein, are words of description and illustration, rather than words of limitation. Furthermore, although the embodiments have been described herein with reference to particular means, materials, techniques, and implementations, the embodiments are not intended to be limited to the particulars disclosed herein; rather, the embodiments extend to all functionally equivalent structures, methods and uses, such as are within the scope of the appended claims. It will be understood by those skilled in the art, having the benefit of the teachings of this specification, that the embodiments disclosed herein are capable of modifications and other embodiments may be effected and changes may be made thereto, without departing from the scope of the embodiments disclosed herein.

1. A lock and release system for a battery of a vehicle, comprising:
a plurality of female cavities disposed on the batter; and
a plurality of mail engagement disposed on the vehicle, and
characterized in that
each of the male engagements comprises a pair of projections connected by a flat member, a plurality of openings on the flat member, a connector disposed parallel to the flat member between said pair of projections and a push-pull rod passing through an opening on a flat member of each of the male engagement,
each of the female cavities comprises an opening, a channel and a pair of grooves,
each of the male engagements, configured to reversibly engage with each of the female cavities, locks the battery onto a battery bay of the vehicle. and
a pull motion to the push-pull rod releases the male engagements from the female cavities, releasing the battery from the electric vehicle.

2. The lock and release system as claimed in claim 1, wherein the plurality of male engagements are secured using a pair of screws onto the battery bay using a bracket.

3. The lock and release system as claimed in claim 1, wherein the plurality of female cavities are integrated onto a top surface and a plurality of individual modules are disposed on each of longitudinal surfaces of the battery.

4. The lock and release system as claimed in claim 1, wherein the system comprises a battery lock mechanism, including a pair of grooves of the plurality of the female cavities complementary to a ledge provided at an edge of each of the pair of projection of the plurality of male engagements, to lock the battery into the battery bay of the vehicle.

5. The lock and release system as claimed in claim 1, wherein the flat member includes at least three openings, and the push-pull road passing through the middle opening.

6. The lock and release system as claimed in claim 1, wherein a pull to the push-pull rod causes the connector to flex in an upward direction, causing the pair of projection to move close with respect to each other, in turn to release the pair of projections from the female cavities, to release the battery from the chassis of the electric vehicle.

7. The lock and release system as claimed in claim 1, wherein the pair of projections and the female cavities is surface treated with agents to harden and avoid wear and tear.
